(19) United States
(12) Patent Application Publication
(10) Pub. No.: US 2004/0118393 A1
(43) Pub. Date: Jun. 24, 2004

(54) Grate assembly for a charcoal grill

(75) Inventor: Robert K. Schulte, Augusta, KS (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: The Coleman Company, Inc., Wichita, KS

(21) Appl. No.: 10/732,649

(22) Filed: Dec. 10, 2003

Related U.S. Application Data
(62) Division of application No. 10/214,866, filed on Aug. 7, 2002, now abandoned.

(51) Int. Cl. A47J 37/00

(52) U.S. Cl. 126/25 R; 126/153

(57) ABSTRACT

A portable grill that folds to a very compact configuration, with the legs folded underneath a firebox and a side table folded beneath the legs. The side table may be folded outward to present the handle for transporting the grill on wheels while the legs are folded underneath the grill. A charcoal grate assembly reconfigures to provide a very efficient and fast manner of removing charcoal from the firebox. An ash pan located below the firebox includes an ash pan lid that allows charcoal to be quickly extinguished, and the grill to be cooled in a very short period of time so that it is ready for transport. A hinge provides a convenient manner of keeping a lid for the grill in a raised position, even in windy conditions.

### REFERENCE TO RELATED APPLICATION

This application is a divisional application of U.S. patent application Ser. No. 10/214,866, filed Aug. 7, 2002, and incorporated herein by reference.

### TECHNICAL FIELD OF THE INVENTION

The present invention is directed to grills, and more specifically to outdoor grills that utilize charcoal.

### BACKGROUND OF THE INVENTION

Camping and tailgating are popular recreational activities enjoyed by many. Some people camp so that they may enjoy the outdoors, and others use camping as an inexpensive alternative to staying in hotels. Tailgating is a great way to meet and eat before ballgames, and has become quite the ritual for many season ticket holders.

Although many campers enjoy being in the outdoors, often campers like to enjoy the luxuries of home while camping. For example, many campers bring lounge chairs or hammocks, portable air mattresses or cots, and similar items to make a camping experience more comfortable.

One thing that most campers enjoy while camping or tailgating is cooking on an open fire. Typically, at home, individuals will use a grill for this purpose. However, many conventional grills do not fold down to a convenient size, so their portability and use for camping or tailgating are limited.

Another problem with use of typical charcoal grills for camping or tailgating is the associated mess and ash by-product of grilling using charcoal. Often, after a user has completed cooking on a charcoal grill, the charcoal must continue to burn or smolder until all of the charcoal is the grill has burned. Alternatively, the charcoal must be poured out of the grill, which in and of itself is a dangerous process, and the charcoal must be put out by smothering or quenching. Often, if the user is in a hurry to leave a camping area or is using a grill for a tailgating experience, the user does not want to wait until the charcoal has completely burned. In addition, if used for tailgating, the user may not have a place to deposit the ash or remaining charcoal.

### SUMMARY OF THE INVENTION

The present invention provides a portable grill that includes a number of features that enhance portability and use for camping or tailgating. In accordance with an aspect of the present invention, the portable grill includes a charcoal grate assembly having two or more charcoal grates. The charcoal grates are arranged in a first position where individual grate wires are closely spaced so that charcoal pieces typically do not fall therethrough. The grate wires may be moved relative to one another so that spacing is increased and the charcoal pieces may fall through the charcoal grate assembly.

In accordance with another aspect of the present invention, the portable grill includes an ash pan located at the bottom of the grill for catching ashes as they fall through the charcoal grate assembly. The bottom sides of a firebox for the grill slope downward to the ash pan so that ashes falling through the charcoal grate assembly are accumulated in the ash pan.

In accordance with another aspect of the present invention, the ash pan includes a lid that seals the top of the ash pan. The lid may be configured so that it may be placed upon the ash pan while the ash pan is mounted below the firebox, and may include a hook or handle that permits it to be hung on the bottom of the grill. Because the ash pan lid seals the ash pan, oxygen and air is blocked from the smoldering charcoal in the ash pan, causing the fire or other smoldering ashes within the ash pan to extinguish after a short period of time.

In accordance with yet another aspect of the present invention, the ash pan lid may be placed over the ash pan, and the ash pan may be removed from the bottom of the grill by sliding it out from underneath the bottom of the grill. A handle may be provided on the side of the ash pan for permitting removal from the grill and easy transport without subjecting a user to an ash pan that is heated to an uncomfortably high temperature. The extinguished ashes may then be transported in the enclosed ash pan, which may conveniently be placed back under the firebox or may fit in the grill for temporary storage until reaching a location where the ashes may be safely dumped.

In accordance with still another aspect of the present invention, the portable grill includes a hinge that biases a lid for the portable grill into an open position while the grill is being used. This feature permits the lid to remain open even in windy conditions.

In accordance with another aspect of the present invention, the legs for the grill fold under the grill exposing wheels on one side. The wheels are positioned so that they are usable for relocating the grill while extended or when folded. A side table includes a handle that may be used to pull the grill on the wheels to a desired location. The side table may be removed for storage, and may be folded out during use to provide a work surface. The legs may provide a support for the extended side table so that it remains in the work surface position.

Other advantages will become apparent from the following detailed description when taken in conjunction with the drawings, in which:

### BRIEF DESCRIPTION OF THE DRAWINGS

FIG. 1 is an isometric view of a grill incorporating the present invention, showing a lid raised so as to expose a cooking grate;

FIG. 2 is a rear isometric view of the grill of FIG. 1, with the lid closed;

FIG. 3 is a rear isometric view of the grill of FIG. 1, with the lid removed for detail, and showing a charcoal grate assembly in a cooking position;

FIG. 4 is a rear isometric view of the grill of FIG. 1, similar to FIG. 3, with the lid removed for detail, and the charcoal grate assembly moved to an opened, cleaning position;

FIG. 5 is a partial cutaway isometric view of the grill of FIG. 1, showing an ash pan and ash pan lid for the grill removed from the grill;

FIG. 6 is a partial cutaway view showing the installation of the ash pad and ash pan lid in the bottom of a firebox for the grill of FIG. 1;

FIG. 7 is a cutaway view showing a hinge for the lid of the grill of FIG. 1, with the lid in a closed position;

FIG. 8 is a cutaway view of the hinge of FIG. 7, similar to FIG. 7, but showing the hinge in a position where the lid is opened; and

FIG. 9 is an isometric view of the grill of FIG. 1, showing the grill in a transport position, with a side table of the grill extended and providing a handle for the grill.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention.

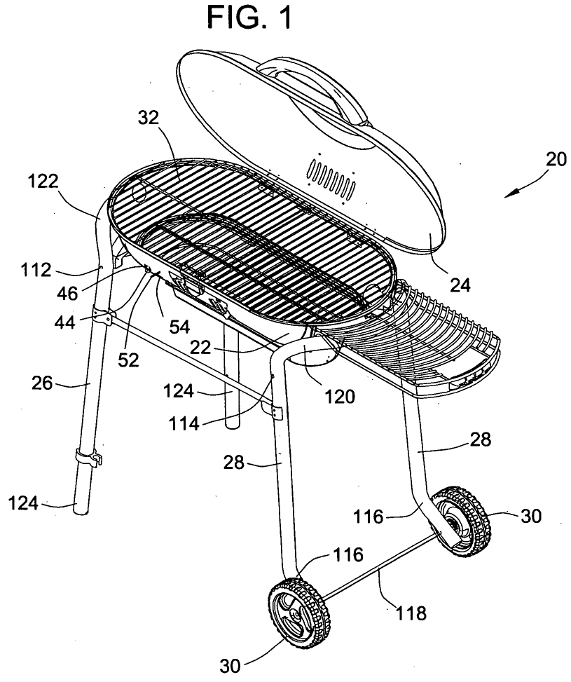

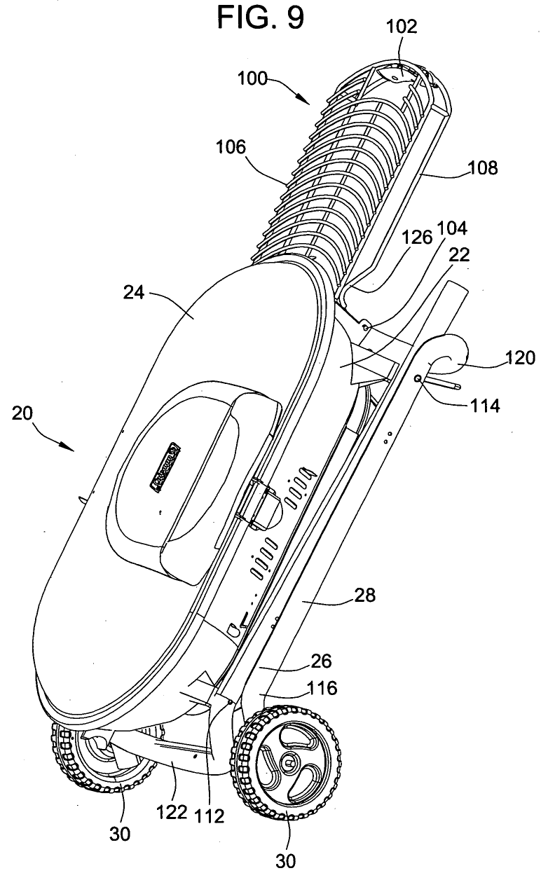

Referring now to the drawings, in which like reference numerals represent like parts throughout the several views, FIG. 1 shows a grill 20 in accordance with one embodiment of the present invention. The grill 20 includes a firebox 22 and a lid 24. The firebox 22 is mounted on legs 26, 28. Each of the legs 26, 28 includes a pair of posts that extend from the firebox 22 toward the ground. The leg 28 on the right side of the grill 20 includes wheels 30 at a lower end. In accordance with one aspect of the present invention, as can be seen in FIG. 9, the legs 26, 28 may be folded underneath the firebox 22 so that the grill 20 may be compactly stored or transported. This aspect of the present invention is further described below.

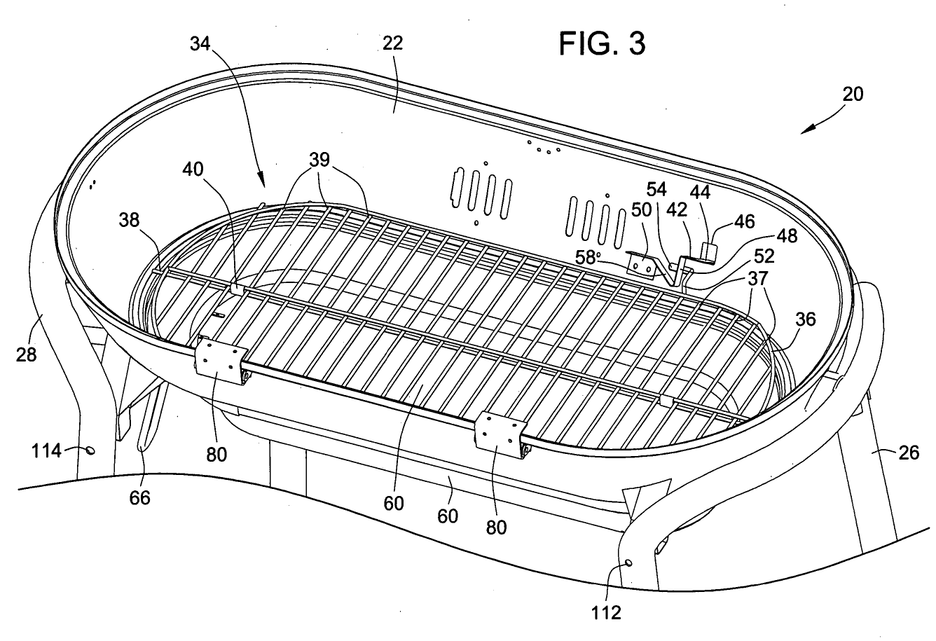

As can be seen in FIG. 1, the grill 20 includes a cooking grate 32 removably mounted at an upper portion of the firebox 22. Mounted below the cooking grate 32 is a charcoal grate assembly 34 (FIG. 3). The charcoal grate assembly 34 includes an upper grate 36 and a lower grate 38. The upper grate 36 and the lower grate 38 each include a plurality of parallel wire grates 37, 39 that are evenly spaced along their lengths. The wire grates 37 on the upper grate 36 are spaced similar to the wire grates 39 on the lower grate 38, and may be spaced, for example, 1.5 inches from one another. The upper grate 36 is placed on top of the lower grate 38, and in accordance with one aspect of the present invention, the wire grates 37 for the upper grate 36 are located on the lower surface of the upper grate, and the wire grates 39 for the lower grate 38 are located on the upper surface of the lower grate. In this manner, the wire grates 37 for the upper grate 36 are located between the wire grates 39 for the lower grate 38. In addition, the wire grates 37, 39 are sandwiched between the grates 36, 38.

The upper grate 36 is attached to the lower grate 38 by a pair of rings 40. The rings 40 clamp around a central rod for each of the grates, and permit sliding of the upper grate 36 relative to the lower grate 38. Other attachment mechanisms may be used to permit sliding movement of the two grates relative to one another, including attachments to the firebox 22 or other portions of the grill 20 independent of attachment of the two grates 36, 38 to each other. However, use of the rings 40 is advantageous in that the rings 40 provide alignment, allows a user to easily remove and assemble the charcoal grate assembly 34, and provides proper spacing of the wire grates 37 and 39 when the charcoal grate assembly is in a cooking position, as further described below.

When cooking, as can be seen in FIG. 3, the upper grate 36 is kept to the far right in FIG. 3 so that the wire grates 37 for the upper grate 36 are centered between the wire grates 39 for the lower grate 38. The rings 40 prevent movement of the upper grate 36 any further to the right. In this position, the spacing between the wire grates 37 for the upper grate 36 and the wire grates 39 for the lower grate 38 is such that full pieces of charcoal do not fall through the wire grates. As such, the charcoal is supported on the charcoal grate assembly 34.

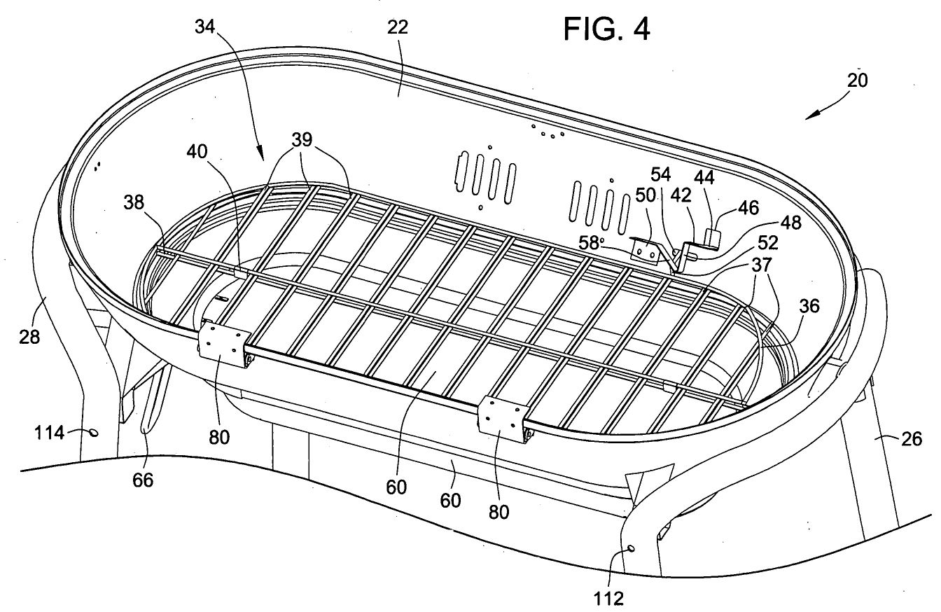

As can be seen in FIG. 4, the upper grate 36 may be moved relative to the lower grate 38 so that the wire grates 39 of the upper grate are adjacent to the wire grates 37 of the lower grate 36. As such, charcoals on the charcoal grate assembly 34 may fall through the charcoal grate assembly. This position is a cleaning position of the charcoal grate assembly 34. While the upper grate 36 is described as moving relative to the lower grate 38, the lower grate may instead move relative to the upper grate, or both may move to provide cleaning and cooking positions.

To prevent the upper grate 36 from unintentionally sliding relative to the lower grate 38, a catch 42 is provided on the inside of firebox 22. The catch 42 includes an extension 44 that extends out of a vertical slot 46 on the front of the firebox. The extension 44 is shown extending out of the vertical slot 46 in FIG. 1, for example. The catch 42 includes a downward shoulder 48 and is attached to the inside of the firebox 22 at a flange 50. The catch 42 is positioned so that the extension 44 is normally in the bottom of the vertical slot 46, and is preferably resilient and flexible so that the extension 44 is normally biased toward the bottom of the vertical slot 46, but may be moved upward by a user via the flexibility of the catch 42, with the upward movement limited by the extension 44 engaging the upper and lower surfaces of the vertical slot 46. To provide flexibility and resilience, the catch 42 may be made of spring steel, for example.

An extension 52 is attached to the upper grate 36 and extends outward and forward from the upper grate 36.. The extension 52 extends through a horizontal slot 54 in the firebox 22. The extension 52 can be seen extending out of the horizontal slot 54 in FIG. 1, for example. The extension 52 is arranged so that it engages the shoulder 48 when the charcoal grate assembly 34 is in the cooking position. The shoulder prevents the upper grate 36 from moving to the cleaning position. That is, when the catch 42 is in the lower position, defined by the extension 44 being at the bottom of the vertical slot 46, the extension 52 abuts against the shoulder 48, preventing movement of the upper grate 36 relative to the lower grate 38.

To move the charcoal grate assembly 34 to the cleaning position from the cooking position, a user may lift the extension 44 in the vertical slot 46, moving the shoulder 48 out of the way of the extension 52. The user may then grasp the extension 52 (the use of gloves is recommended if the charcoal grate assembly 34 is hot), which extends outside of the firebox 22, and slide the upper grate 36 relative to the lower grate 38 so as to move the charcoal grate assembly 34 to the cleaning position. The wire grates 37 engage the wire grates 39 at the end of the movement, and prevent further movement.

The shoulder 48 shown in the drawings includes a sloped rear surface 58. When the upper grate is released by lifting the extension 44 of the catch 42, charcoal on the charcoal grate assembly 34 may press the upper grate 34 to the left (i.e., by lodging between the wire grates 37 for the upper grate 36 and the wire grates 39 for the lower grate 38). This movement may be continued by the user releasing the catch 42 and the sloped rear surface 58 engaging the extension 52 and urging the upper grate 36 to the open position. To this end, the catch 42 is biased downward, for example, by a spring action in the material for the catch, as described above. The user may encourage this action by pressing down on the extension 44 of the catch 42.

The wire grates 37, 39 may be any structure that, in a first position has smaller openings than in a second position, the second position being formed by movement of a first grate relative to the second. Preferably, the wire grates alternatively provide the smaller openings and larger openings over the surface of the charcoal grate assembly, so that charcoal may be released regardless of its location on the charcoal grate assembly. Also, although described with reference to two grates, the charcoal grate assembly may have any number of grates that performs a similar function.

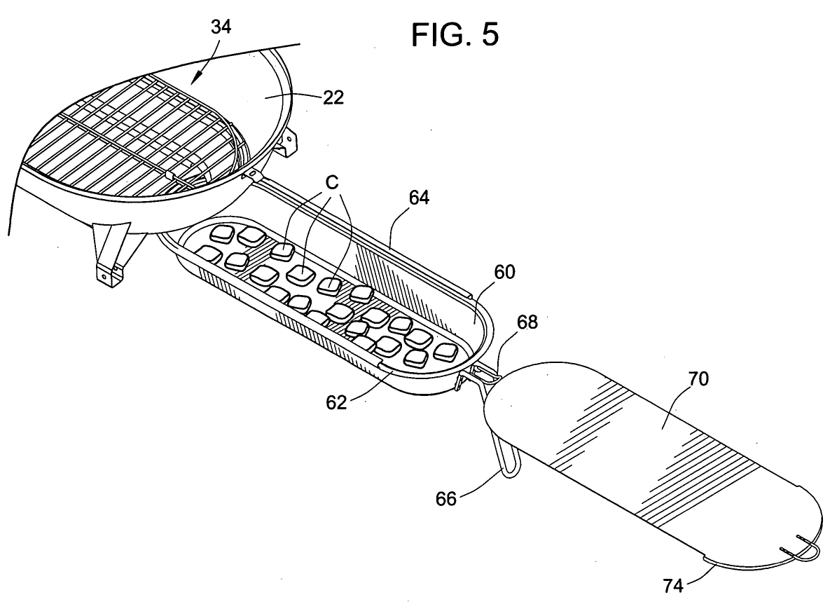

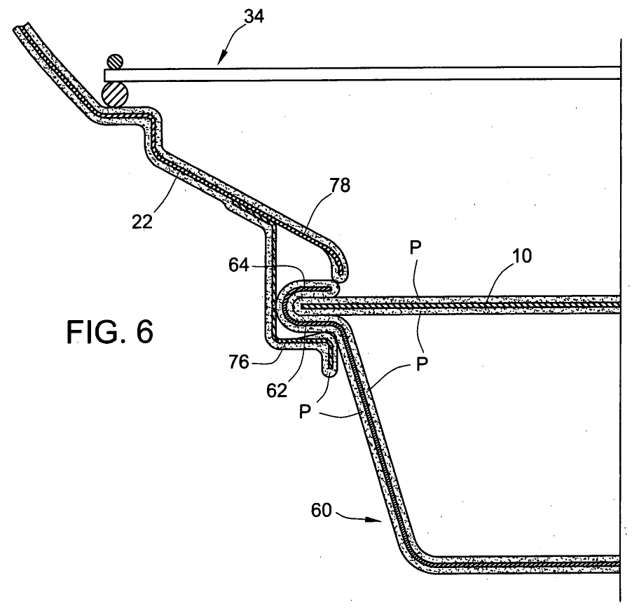

In accordance with another aspect of the present invention, as best shown in FIG. 5, an ash pan 60 is removably positioned below an open bottom of the firebox 22 and is situated so that it can receive ashes that fall through the charcoal grate assembly 34, either during the grilling process, or as a result of moving the upper grate 36 relative to the lower grate 38 as described above. The ash pan 60 includes an outer rim 62 extending around its perimeter. A lip 64 (best shown in FIG. 6) extends upward and inward from the rim 62, around all but one end of the ash pan 60. A handle 66 is attached at an end of the ash pan 60, and extends downward so that a user may pull the ash pan 60 outward from underneath the firebox 22 without having to grasp the sides of the ash pan 60. A hook 68 is located just above the handle 66, and extends outward from the ash pan 60. If desired, another handle (not shown) may be provided on the opposite side of the ash pan 60 to permit easier carrying of the ash pan.

An ash pan lid 70 is provided for fitting over the ash pan 60. The ash pan lid 70 matches the contour of the top of the ash pan 60, and includes a ring handle 72 at one end. At the same end, a lip 74 extends around an edge of the ash pan lid 70. The lip 74 extends around a portion of the ash pan lid 70 that corresponds with the portion of the ash pan 60 that does not include the lip 64.

The lower parts of the firebox 22 are shaped so that ash falling through the charcoal grate assembly 34 either falls directly into the ash pan 60 (when the ash pan is in place on the bottom of the firebox 22), or if dropped to the sides of the ash pan 60, tumbles down into the ash pan 60. An opening at the bottom of the firebox 22 receives the ash pan 60. At the opening is formed a ledge 76 (FIG. 6). The ledge 76 extends downward and then turns at an angle to extend horizontally, providing a support for the rim 62 when the ash pan 60 is in place underneath the firebox 22. The ledge 76 may alternatively extend at an angle to horizontal, or may otherwise be arranged to receive the ash pan 60.

Above the ledge 76, extending outward from sidewalls of the firebox 22, is formed a downward and inward extending lip 78. The downward and inward extending lip 78 is arranged and configured so that it extends inside of the lip 64 of the ash pan 60 when the ash pan is positioned below the firebox 22. In this manner, ash and charcoal that fall through the charcoal grate assembly 34 at the outer edges of the firebox drop along the downward and inward extending lip 78 and into the bottom of the ash pan 60, and not into the groove formed between the lip 64 and the rim 62 of the ash pan 60. Typically, during operation of the grill 20, the ash pan lid 70 is not installed on the ash pan 60, and later installing the ash pan lid 70 may be difficult if ash or charcoal is located between the lip 64 and the rim 62. A similar downward and inward extending lip (not shown) may be positioned to prevent ash or charcoal from falling out of the slot into which the ash pan lid 70 is inserted to close the ash pan 60.

After a user has completed cooking on the grill 20, the user causes charcoal (e.g., the charcoal briquettes C shown in FIG. 5) to fall through the charcoal grate assembly 34 by sliding the upper grate 36 relative to the lower grate 38 as described above. After this action, the ash and charcoal in the firebox 22 is moved into the bottom of the ash pan 60. The user may then slide the ash pan lid 70 between the rim 62 and the lip 64 on the ash pan 60 so as to seal the top of the ash pan. As described above, this installation of the ash pan lid 70 is not significantly hindered by ash and charcoal, because the downward and inward extending lip 78 directs the ash and charcoal away from this area.

The user continues to push the ash pan lid 70 until the ash pan 60 is entirely covered. The lip 64 extends over and around the outer edges of the majority of the pan lid 70 and tightly receives the ash pan lid 70 therein. At the front of the ash pan 60, where the lip 64 does not extend, the lip 74 of the pan lid 70 fits tightly over and around the rim 62 of the ash pan 60. Thus, the two lips 64, 74 aid in sealing the ash pan lid 70 over the ash pan 60. Although the two lips 64, 74 are shown so that together they surround the entire ash pan 60 when the ash pan lid 70 is placed on the ash pan, the lips may cover only a portion, or the lip 74 may not be included, but such alternative embodiments may not seal the ash pan 60 as well.

The lip 64 on the rim 62 of the ash pan 60 causes the ash pan lid 70 to fit tightly on the ash pan 60 so as to block the flow of air into the ash pan. To this end, the ash pan lid 70, the rim 62 and the lip 64 of the ash pan 60 may all be covered with porcelain, as indicated by the letter P in FIG. 6. The porcelain P provides a tight-fitting, but slippery, surface that permits the ash pan lid 70 to slide into the tight fitting provided by the lip 64. In addition, the porcelain P may cover the entire surface of the ash pan 60 and the ash pan lid 70 for protection against the high heat that the charcoal ash can generate, and for easy cleaning. Other materials may be used. For example, the ash pan lid 70 may be made of aluminum or another material. In addition, if desired, a lock, such as a dimple, may be used to hold the ash pan lid 70 in place on the ash pan 60.

By completely closing off the ash pan 60, the ash pan lid 70 forms an impermeable closure of the ash pan 60, closing air off from its contents. As such, placement of the ash pan lid 70 on the ash pan 60 quickly snuffs out any fire or smoldering remaining in the charcoal or ashes that are in the ash pan 60. The fire or glowing ash extinguishes, and the ash pan 60 soon cools so that it may be removed from the firebox 22 and the ash may be poured out of the ash pan 60. Alternatively, the ash pan 60 may be transported with the extinguished ash and charcoal therein, either attached to the grill or removed therefrom, permitting a user to transport the ash to a different location for disposal. In accordance with one aspect of the present invention, the ash pan 60 fits inside the grill 20 for transport.

During grilling, the ash pan lid 70 may be hung on the hook 68 of the ash pan 60, for example, by the ring handle 72 on the ash pan lid 70. In this manner, the ash pan lid 70 is conveniently out of the way, but is easily accessed when needed.

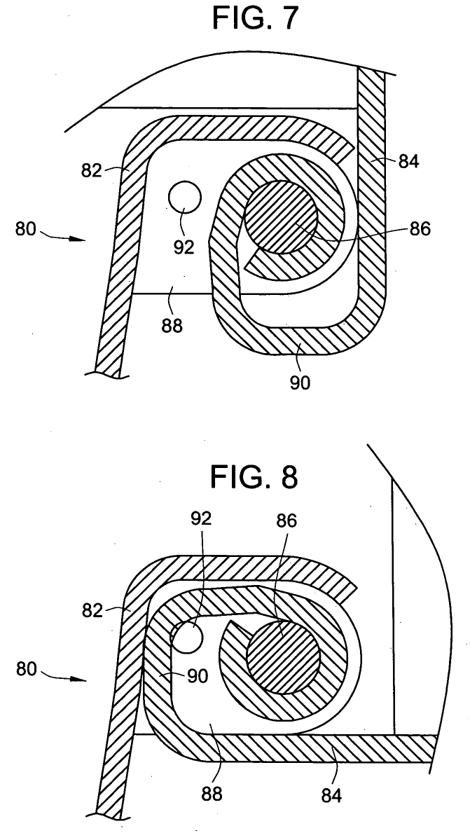

In accordance with another aspect of the present invention, the grill 20 includes a novel hinge 80 (the back of which is shown in FIG. 3, and the details of which are shown in FIGS. 7 and 8) for attachment of the lid 24 to the firebox 22. In the embodiment shown, there are two hinges 80 that are used to hold or attach the lid 24 to the firebox 22. However, one or more hinges 80 may be used for attaching the lid 24 to the firebox 22. For ease of description, the structure of only one hinge 80 is described.

The hinge 80 includes a stationary plate 82 and a rotating plate 84. The stationary plate 82 is connected to the back edge of the firebox 22. The rotating plate 84 is connected to the lid 24. The position of the hinge 80 shown in FIG. 7 is the position that the stationary plate 82 and rotating plate 84 are in relative to one another when the lid 24 is closed onto the firebox 22. The position shown in FIG. 8 is the position of the rotating plate 84 relative to the stationary plate 82 when the lid 24 is in an open position relative to the firebox 22.

A hinge pin 86 is attached to a pin plate 88 that extends perpendicularly outward from the stationary plate 82. The rotating plate 84 is attached on the hinge pin 86 and is free to rotate on the hinge pin 86. In the embodiment shown, the rotating plate 84 includes a U-shaped extension 90. The U-shaped extension 90 is arranged so that it extends from an attachment of the rotating plate 84 to the hinge pin 86 and then reverses direction and extends upward and past the hinge pin. In this manner, the U-shaped extension 90 forms a hollow channel on the back side of the rotating plate 84. This hollow channel rotates with the rotating plate 84.

The pin plate 88 includes a dimple 92 on its inner surface. The dimple 92 is located between the hinge pin 86 and the stationary plate 82, and its convex portion faces inward toward the stationary plate 82. If desired, a similar pin plate 88 and dimple 92 may be located on the opposite side of the hinge pin 86.

The dimple 92 is preferably aligned and configured so that the sides of the U-shaped extension 90 engage the dimple 92 when the rotating plate 84 is rotated relative to the stationary plate 82. As such, the dimple 92 slightly interferes with rotation of the rotating plate 84 relative to the stationary plate 82. That is, the outer edges of the stationary plate 82 engage and roll over the dimple 92 when the lid is moved to the open position. In this manner, the lid 24 must be pressed to the upper, open position relative to the firebox 22 to overcome the interference caused by the dimple 92.

After the U-shaped extension 90 has passed over the center of the dimple 92, the dimple urges the lid 24 into the upward position. The dimple 92 creates interference for return of the rotating plate 84 in the opposite direction (i.e., closing of the lid 24). To close the lid 24 at this point, the U-shaped extension 90 must back over the dimple 92. This operation can be performed by a user by applying slight force to the lid 24.

The interference of the dimple 92 prevents the lid from accidentally being blown shut or being bumped and slamming shut on top of the firebox 22. The dimple 92 is preferably situated such that it slightly engages the U-shaped extension 90 when the lid 24 is in the upright position. As such, the lid 24 does not have any “play” at the upper position, preventing wobbling of the lid 24 and possible inertia by wind that might permit the lid 24 to be blown shut.

The rotating plate 84 and the dimple 92 are preferably formed of materials that do not wear upon multiple cycles of opening and closing of the lid 24. For example, the dimple 92 may be stamped out of the pin plate 88, which may be formed of a stainless steel, and the rotating plate 84 may also be made out of stainless steel. Stainless steel is slightly flexible so that it may move past the dimple 92, and tends not to wear away or bend as a result of a very large number of openings and closures of the lid 24.

The dimple 92 may be any type of rounded protrusion that impedes movement of the lid 24 relative to the firebox 22, and may be arranged in different locations relative to the stationary plate 82 to engage a surface of the rotating plate 84 when the hinge 80 is rotated. In addition, a dimple or other rounded protrusion may be fixed to rotate with the rotating plate 84 and may engage a surface fixed with the stationary plate and provide similar results. In addition, while the dimple 92 is described as being mounted on the hinge 80, the benefits of the dimple or a similar protrusion may be incorporated into the lid 24 and/or the firebox 22, independent of hinges connecting the two.

Similarly, the U-shaped extension 90 is not required, but provides a surface for engaging and rolling over the dimple 92. Other surfaces may be provided, which may or may not be attached or connected to the rotating plate 84.

A side table 100 is hinged to the side of the firebox 22 and includes a handle 102. The side table 100 may, for example, be attached by hinge pin 104 to the side of the firebox 22. The side table 100 also includes a support surface 106 on the top side thereof, and rails 108 along sides of the support surface. A variety of grill accessories may be hung on the rails 108. In addition, pots, pans, grill accessories, or other items may be placed on the support surface 106 during grilling.

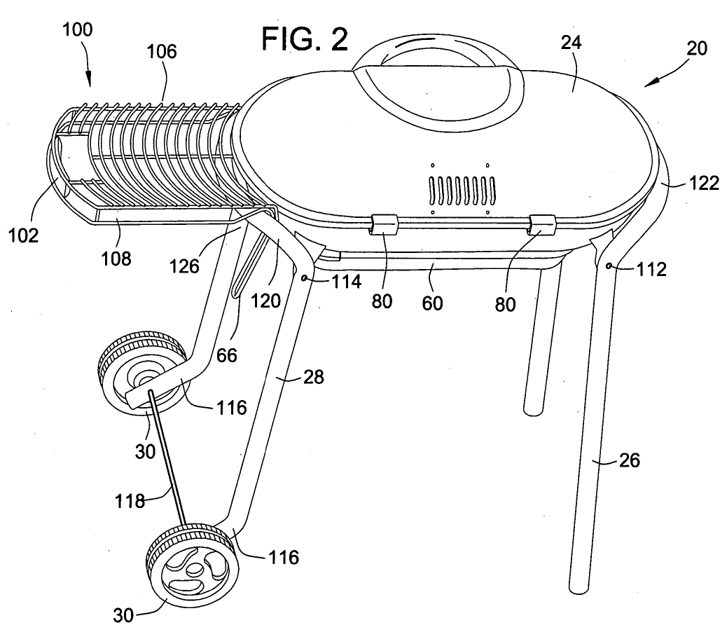

The leg 26 is mounted on hinge pins 112 (only one of which is shown in FIGS. 1 and 2, and the others of which can be seen in FIGS. 3 and 4) for rotation. Likewise, the leg 28 is mounted on hinge pins 114 for rotation. The leg 28 bends outward at an angled bottom 116. The wheels 30 are mounted at a distal end of the angled bottom 116 on an axle 118. The leg 28 includes an upper loop 120 at an upper section. Two bars for the leg 28 extend downward from the firebox 22 to the wheels 30, and are connected by the upper loop 120 and the axle 118, and thus move as a single unit. Similarly, the leg 26 includes an upper loop 122 that causes two posts 124 of the leg 26 to move together as a unit. A stay 126 may be provided to stabilize the legs 26, 28 in the opened position.

As can be seen in FIG. 9, the legs 26, 28 may be folded into one another so as to be flat against the bottom of the firebox 22. In accordance with another aspect of the present invention, the legs 26, 28 fold against the firebox 22 so that the grill 20 may be easily transported or stored. To this end, the leg 26 rotates up and out of the way of the legs 28. The leg 28 may then rotate upward to capture the leg 26. The leg 26 is first folded against the bottom of the firebox 22, and the leg 28 is folded against it. The angled bottom 116 of the legs 28 cause the wheels 30 to be extended outward from the bottom of the firebox 22.

When the legs 26, 28 are folded, the side table 100 may be extended outward and may be grasped by the handle 102 to pull the grill 20 on the wheels 30 to a desired location. During this pulling motion, the grill 20 rolls on the wheels 30, and the legs 26, 28 are held in the compact configuration against the firebox 22 by the pressure of the wheels 30 upward against the legs.

When the side table 100 is folded to the outward position and the legs 26, 28 are folded to the downward position, the upper loop 120 of the leg 28 is received in a cut-out 126 (best shown in FIG. 2) in the bottom of the side table 100. This connection between the upper loop 120 and bottom of the side table 100 helps to hold the side table into position when the legs are extended downward. In addition, the side table 104 is eccentrically mounted so that the side table may be folded down and around the upper loop 120 of the leg 28 when in a compact configuration. To this end, the work surface 106 and rails 108 of the side table 100 are spaced upward from the hinge pin 104 so that they are eccentrically mounted relative to the hinge pin 104. Thus, the work surface 106 and rails 108 rotates eccentrically downward about the hinge pin 104, and outwardly and around the upper loop 120 so that the side table 100 may be situated against the bottom of the legs 26, 28 when the grill 20 is in the compact, storage position, as shown by the arrow 128 in FIG. 9.

The side table 100 may also be removed from the grill 20. To this end, the side table 100 may be removably connected to the hinge pin, such as by the hinge pin 104 having legs that may be biased inward to be removed from holes on the grill 20, or by having legs that can be snapped into place. Other removable connections may be used.

The grill 20 of the present invention provides a number of benefits over prior art grills. For example, the grill 20 folds to a very compact configuration, with the legs 26, 28 folded underneath the firebox 22. The side table 100 may be removed and stored inside the grill 20. The side table 100 may be folded outward to present the handle 102 for transporting the grill 20 on the wheels 30 while the legs are folded underneath the grill 20. When the legs 26, 28 are folded down, the grill 20 may be moved by grasping the upper loop 122 of the leg 26, lifting the left side of the grill in FIG. 1, and rolling the grill on the wheels 30.

The charcoal grate assembly 34 provides a very efficient and fast manner of removing charcoal from the firebox 22. The ash pan 60 and ash pan lid 70 add a further convenience in that charcoal may be quickly extinguished, and the grill may be cooled in a very short period of time so that it is ready for transport. If desired, instead of dumping the ashes from the ash pan 60, the ashes may be transported in another location with the ash pan lid 70 on the ash pan 60, where the ashes may then be properly disposed. The hinge 80 provides a convenient manner of keeping lid 24 in a raised position, even in windy conditions.

While the grill 20 is described as including the many aspects of the present invention, any single aspect or combination of aspects may be used on a grill. Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A grill, comprising:
a charcoal grate assembly, comprising:
a first grate having a plurality of first wire grates; and
a second grate, having a plurality of second wire grates, at least one of the first and second grate being movable relative to the other first and second grate between first and second positions,;
wherein, in the first position, the plurality of first wire grates are spaced a first distance from the plurality of second wire grates, and in the second position, the plurality of first wire grates are spaced a second distance from the plurality of second wire grates, the second distance being greater than the first distance.

2. The grill of claim 1, wherein the second distance is sufficient to let charcoal briquettes pass therethrough.

3. The grill of claim 1, wherein the plurality of first wire grates comprises a plurality of first parallel wire grates, the first parallel wire grates being spaced an equal first amount relative to each other, and the plurality of second wire grates comprises a plurality of second parallel wire grates, the second parallel wire grates being spaced an equal second amount relative to each other.

4. The grill of claim 4, wherein the first parallel wire grates are situated between the second parallel wire grates.

5. The grill of claim 4, wherein movement between the first and second positions comprises movement of the second parallel wire grates toward the first parallel wire grates.

6. The grill of claim 5, further comprising a catch that is configured in one position to prevent movement between the first position and the second position and in an other position to allow movement between the first position and the second position.

7. The grill of claim 6, further comprising a firebox, wherein charcoal grate assembly is located in the firebox, and wherein the catch may be accessed outside the firebox for manipulation between the one position and the other position.

8. The grill of claim 5, wherein the first parallel wire grates are located above the first grate, and wherein the second parallel wire grates are located under the second grate.

9. The grill of claim 1, further comprising a catch that is configured in one position to prevent movement between the first position and the second position and in an other position to allow movement between the first position and the second position.

10. The grill of claim 9, further comprising a firebox, wherein charcoal grate assembly is located in the firebox, and wherein the catch may be accessed outside the firebox for manipulation between the one position and the other position.
